(19) United States
(12) Patent Application Publication
(10) Pub. No.: US 2014/0189548 A1
(43) Pub. Date: Jul. 3, 2014

(54) DOMAIN SPECIFIC LANGUAGE USER INTERFACE

(71) Applicant: CA, INC., Islandia, NY (US)

(72) Inventor: Kevin W. Werner, Colorado Springs, CO (US)

(73) Assignee: CA, INC., Islandia, NY (US)

(21) Appl. No.: 13/733,200

(22) Filed: Jan. 3, 2013

(51) Int. Cl. G06F 3/0481

(52) U.S. Cl. CPC G06F 3/0481
USPC 715/762

(57) ABSTRACT

Providing a user interface for editing a domain specific language expression includes displaying, by a master widget, the domain specific language expression within the user interface. This displaying of the domain specific language expression includes displaying, by a compound expression widget, a compound expression of the domain specific language expression and displaying the compound expression includes displaying, by a first expression widget, a first argument of the compound expression, and displaying, by a second expression widget, a second argument of the compound expression. The method further includes detecting, by the compound expression widget, a change to either of the first expression widget and the second expression widget; and in response to the change being detected, updating, by the master widget, the compound expression based on the change.

### BACKGROUND

The present disclosure relates to user interfaces, and more specifically, to user interfaces for domain specific languages.

A domain specific language is a programming language or specification language dedicated to a particular problem domain, a particular problem presentation technique or a particular solution technique. Alternatively, a general purpose programming language includes features that can be applied to provide an automated solution to more than one particular problem domain. Domain specific languages are typically beneficial when using such a language allows the particular type of problem, or its solution, to be expressed more clearly than an existing general-purpose programming language.

As a result, domain specific languages are usually designed so as to involve very specific grammars or syntax that are closely related to the problems or solutions of the particular problem domain. Thus, a skilled general-purpose programmer may not necessarily be a proficient programmer in a domain specific language. Accordingly, a user interface may also be designed that attempts to assist a user in performing operations using the domain specific language; in particular, such a user interface may try to simplify some of the more complex aspects of the syntax or grammar of the domain specific language. In some instances, a user interface may simplify what the user can accomplish to such a degree that many features and strengths of the domain specific language are obscured and in other instances using the user interface may be just as difficult as the domain specific language itself.

### BRIEF SUMMARY

According to one aspect of the present disclosure, a method of providing a user interface for editing a domain specific language (DSL) expression includes displaying, by a master widget, the DSL expression within the user interface. This displaying of the DSL expression includes displaying, by a compound expression widget, a compound expression of the DSL expression and displaying the compound expression includes displaying, by a first expression widget, a first argument of the compound expression, and displaying, by a second expression widget, a second argument of the compound expression. The method further includes detecting, by the compound expression, a change to either of the first argument of the compound expression and the second argument of the compound expression; and in response to the change being detected, updating the compound expression widget, based on the change.

According to another aspect of the disclosure, a computer program product for providing a user interface for editing an expression includes a computer readable storage medium having computer readable program code embodied therewith. This computer readable program code includes computer readable program code configured to: display, by a widget, the DSL expression within the user interface; display, by a compound expression widget, a compound expression of the DSL expression; display, by a first expression widget, a first argument of the compound expression; to display, by a second expression widget, a second argument of the compound expression; detect, by the compound expression, a change to either of the first expression argument and the second expression argument; and, in response to the change being detected, update, by notification to the widgets, the DSL expression based on the change.

According to yet another aspect of the disclosure, a system of providing a user interface for editing a DSL expression includes a widget configured to display the DSL expression within the user interface; a compound expression widget configured to display a compound expression of the DSL expression; a first expression widget configured to display a first argument of the compound expression, and a second expression widget configured to display a second argument of the compound expression. The system also includes that the compound expression widget is further configured to detect a change to either of the first expression argument and the second expression argument; and the widget is configured to, in response to the change being detected, update the expression based on the change.

### BRIEF DESCRIPTION OF THE DRAWINGS

Aspects of the present disclosure are illustrated by way of example and are not limited by the accompanying figures with like references indicating like elements.

FIG. 1 illustrates an example computing environment in which a user interface for a domain specific language can be deployed in accordance with the principles of the present disclosure.

FIGS. 2A-2C illustrate a sequence of example user interface screens for editing a query in accordance with the principles of the present disclosure.

FIGS. 2D-2F illustrate the query editing of FIGS. 2A-2C logically arranged in a tree-structure in accordance with the principles of this disclosure.

FIGS. 3A-3G illustrate a sequence of example user interface screens for editing a query in accordance with the principles of the present disclosure.

FIGS. 3H-3M illustrate the query editing of FIGS. 3A-3H logically arranged in a tree-structure in accordance with the principles of this disclosure.

FIG. 4 illustrates a conceptual view of a master widget in accordance with the principles of the present disclosure

FIGS. 5A-5C depict respective flowcharts of different communications processes between widgets in accordance with the principles of the present disclosure

FIG. 5D depicts a flowchart of an example process for providing a user interface in accordance with the principles of the present invention.

FIG. 6 is a block diagram of a data processing system in accordance with the principles of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CORaM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

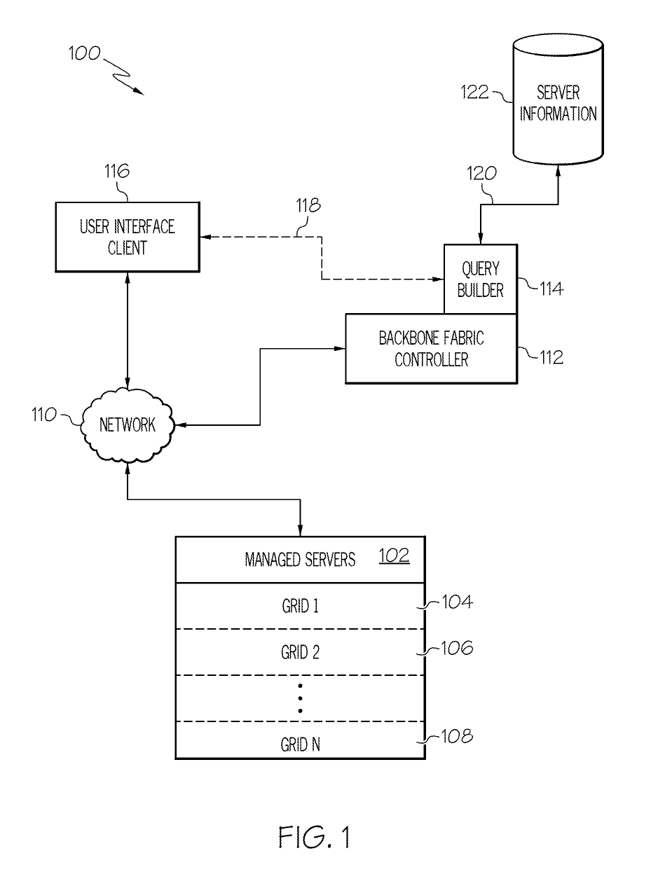

Referring to FIG. 1, a computing environment for deploying a user interface for a domain specific language, in accordance with the principles of this disclosure, is depicted. The computing environment of FIG. 1 is provided merely by way of example so as to allow concrete examples of the features and operations disclosed herein to be provided to assist in understanding all aspects of the present disclosure.

In particular, a managed server computing environment 100 is contemplated in FIG. 1 in which a plurality of managed servers 102 are organized into logical divisions labeled grids. FIG. 1, by way of example, includes GRID 1 (104), GRID 2 (106), and GRID n (108). Each of the managed servers 102 may run an application such as CA AppLogic® as well as a plurality of other software applications. The managed servers 102 may also be in communication, through a network 110, with a controller that determines how the managed servers 102 are arranged into the one or more grids 104, 106, 108. For example, the controller 112 may be a CA AppLogic® Backbone Fabric Controller (BFC) that allows an administrator to assign the managed servers 102 to the various grids 104, 106, 108 and to define how the managed servers 102 (and their respective software applications) may be allocated to various processes and tasks within the computing environment 100.

The BFC 112, for example, accomplishes a number of tasks, one of which involves querying server descriptive information 122 to identify which, if any, of the managed servers 102 satisfy a set of search criteria. More specifically, a query builder, or query editor, 114 may be a functional feature of the BFC 112. As used herein, the terms “query builder” and “query editor” are intended to be interchangeable terms and intended to encompass creating a new query, editing an existing query, and deleting an existing query.

The server descriptive information 122 may be manually added by an administrator when designing the computing environment 100 or may be automatically detected and stored as the computing environment 100 changes. For example, the administrator may create GRID n 108 by using the BFC 112 to assign a particular subset of the managed servers 102 to that grid. The members of GRID n would be stored in the server descriptive information 122. Alternatively, as a new server is added to the managed servers 102, part of the BFC 112 may automatically detect the new server, collect information from the new server about itself, and store that information in the server descriptive information 122.

The query builder 114 may implement a domain specific language that is specialized to easily and efficiently address the problem domain of identifying servers matching a plurality of different attributes. Thus, the communication 120 with the server descriptive information 122 may be in a domain specific syntax and grammar that is cryptic or difficult to understand (but efficient). To aid an administrator of the BFC 112, the query builder 114 may provide a user interface to a user interface client 116 that is easier to use and understand. The user interface is shown logically as the dotted communication line 118 in FIG. 1 and may, for example, be a web-based user interface that allows the administrator to easily build a query that the BFC 112 will convert to the domain specific language query 120 that is ultimately used to identify matching servers from the managed servers 102.

In the example computing environment of FIG. 1, an administrator may have a variety of ways to describe the attributes of the managed servers 102. For example, a “smart tag” can be created that defines a particular class of servers. A “smart tag” called “production capable servers” can be created which specifies that for a server to receive this “smart tag” it must have at least 8 CPU cores and 32 GB of RAM. Thus, when a new server is added to the managed servers 102, the BFC 112 can detect this event and determine if the new server should be tagged with “production capable servers”.

Another way to arrange the managed servers 102 is to simply use a “tag”. For example, the tags “PLATINUM”, “GOLD”, “SILVER” and “BRONZE” may be created and various ones of the managed servers 102 can be assigned one or more of the “tags” by and administrator thereby creating logical subsets of the managed servers 102. The “tags” and “smart tags” allow management of the managed servers 102 within the grids 104, 106, 108 as well as across the grids.

As a simple example, an administrator may want to define selection criteria, or a query, that finds those managed servers 102 which have a tag of either GOLD or SILVER but not if it also has a tag of BRONZE. The domain specific language (DSL) syntax of such a selection criteria may be [[“GOLD”, “SILVER”], [“˜BRONZE”]]. The query builder 114 provides a user interface that may help an administrator build such a query without knowing the grammar or syntax of the DSL.

In general a query, or selection criteria, can be considered as an expression with this expression having a plurality of expression nodes arranged to form the query. Each expression node can be a nested compound expression or a simple expression value. A simple expression value are numbers, strings, etc. A compound expression can be simplistically considered as having an operator and one or more arguments where each argument is another expression node. An expression, for example, related to the DSL syntax in the previous paragraph may be written as ((tag=“GOLD”) OR ((tag=“SILVER”) AND (tag≠“BRONZE”))). In this expression, one expression node is (tag=“SILVER”) and the operator is the “=” sign and “tag” and “SILVER” are the arguments which are simple values. Another expression node in that expression is ((tag=“GOLD”) OR (tag=“SILVER”)) and can be referred to as a compound expression node with nested compound expression arguments. The operator in this case is the “OR” operator and the two arguments are (themselves expression nodes): (tag=“GOLD”) and (tag=“SILVER”).

Before describing details about how the expression nodes and operators may be implemented and how they can detect changes and make appropriate updates based on user interaction with the interface, a few simple examples are provided to help illustrate what steps may be involved in building queries in accordance with the principles of the present disclosure. In general, the user interface described below is constructed from a plurality of widgets, each comprising executable code that is originally sent from the BFC 112 to the user interface client 116. As the user interacts with the widgets of the interface, additional instances of widgets can be created, existing instances of widgets can be edited, and existing instances of widgets can be deleted, with each such action resulting in the interface repainting itself to reflect a current version of the widgets and their corresponding values. Not only does the visual appearance of the user interface change as the widgets are interacted with, but an underlying expression in a domain specific language is modified, updated and represented by the current state of the widgets and their values. The user interface client 116 communicates this expression back to the BFC 112 as the expression and widgets are being changed so that the expression can be evaluated by the BFC 112 in order to provide appropriate results for display within the user interface client 116.

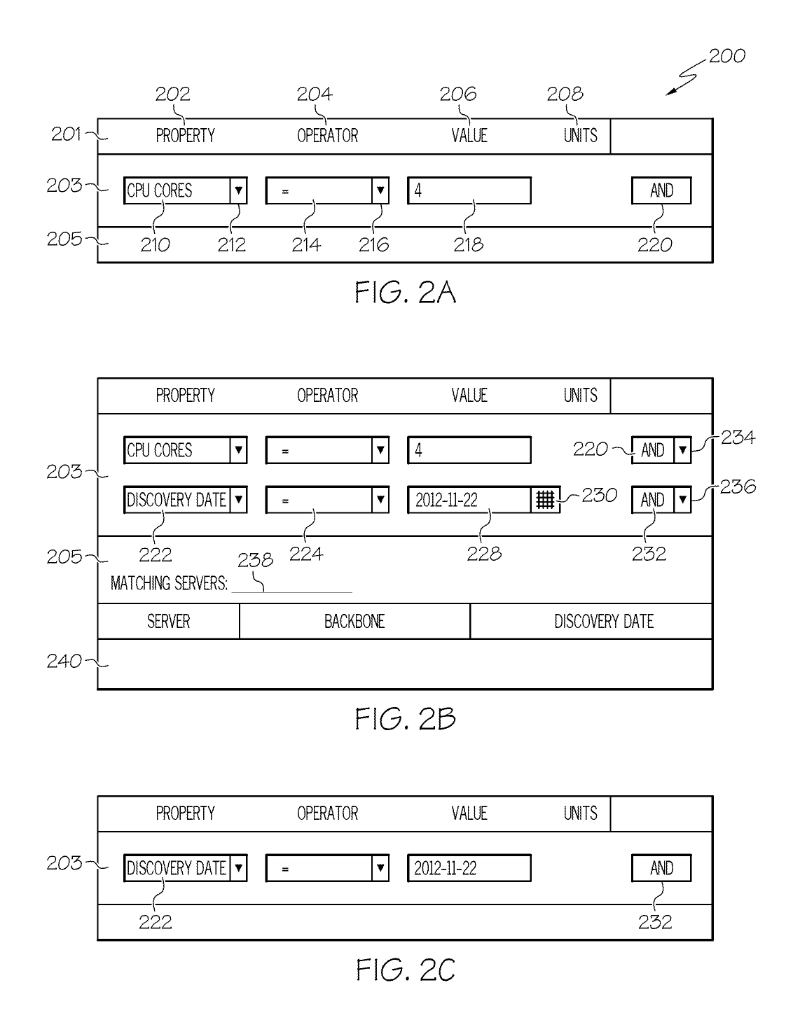

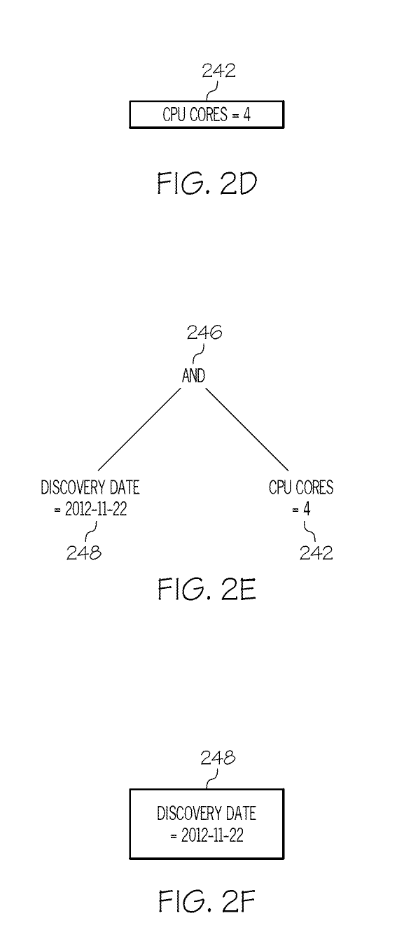

In FIG. 2A an example client user interface screen is depicted having a number of different interface widgets to assist a user in building a query in accordance with the principles of the present disclosure. For example, the general structure of the interface 200 can include a title bar 201 having respective labels 202, 204, 206, 208 pertaining to attributes used to build a query. A middle section 203 can include a line (or lines) of expression(s) portions that make up a query. Each expression line can include a widget 210 that provides a list of user-selectable choices and a control 212 for displaying that list. In particular, the list of choices provided by the widget 210 can relate to the label 202 (e.g., PROPERTY) that is above the widget 210. Another widget 214 (and its control 216) can provide a list of choice related to the label 204 (e.g., OPERATOR) located above the widget 214. Another example widget may be a text box 218 that allows the user to type in a value to be used in this particular.

The expression line in section 203 of FIG. 2A also includes an “AND” button 220 that when selected inserts an AND expression that provides the programming logic to render conjunctive selection criteria when building the query. In the example interface of FIG. 2A, the user has interacted with the widgets to specify part of a first selection criteria such that any server having 4 CPU cores satisfies that selection criteria. To further refine the selection criteria, or to build the query, the user can select the AND button 220 (e.g., by clicking on it). Collectively, the individual widgets of the expression line can be referred to as an “expression node widget”.

As shown in FIG. 2B, selection of the AND button 220 will result in an AND expression being inserted in the expression which then notifies the user interface 200 to add a second expression line (or second expression widget), in section 203, underneath the expression line of FIG. 2A. The expression line added by selecting the AND button 220 is similar to that described above with respect to FIG. 2A, in that there is a widget 222 related to “PROPERTY”, a widget 224 related to “OPERATOR”, and a widget 228 related to “VALUE”. The widget 228 may for example, be a date widget such that its control portion 230, when selected, displays a calendar rather than a simple drop-down list of choices. The second expression line of FIG. 2B also has its own AND button 232. Additionally, a respective delete control 234, 236 is added to each of the AND buttons 220, 232 that allow the user to delete the expression node, if desired.

In the example of FIG. 2B, the user has refined the selection criteria to also include those servers having a discovery date of Nov. 22, 2012. Thus, the interface screen of FIG. 2B reflects a query for servers that satisfy the expression of: ((CPU cores=4) AND (Discovery Date=2012-11-22)). As the user interacts with the interface screen of FIG. 2B, the changing information is dynamically communicated to the expression. The BFC 112 is sent the updated expression and returns information about any matching servers to the third section 205 of the user interface. As shown in FIG. 2B, the user interface can display the number of matching servers (element 238) and a table 240 identifying the matching servers.

If, for example, the user wants to edit the screen of FIG. 2B to eliminate the CPU Core related selection criteria, then the user can select the delete control 234 for the AND button 220. The AND expression node detects this delete event through it's listeners (including the expression node widget) and causes the middle section 203 to be redrawn accordingly. The discovery date widget 222 remains and becomes the sole selection criteria for the master expression FIG. 2C. The AND button 232 may, thus, have its delete control 236 omitted as no further reduction of the expression is permitted.

Selection criteria, expressions, queries, regardless of the terms used may be logically depicted as a tree structure. One of ordinary skill will recognize that the expression is a dynamic data object that can be created and can be temporarily stored while the user is utilizing the user interface client 116 in conjunction with the query builder 114 to define selection criteria (e.g., a query) for finding matching servers. This dynamic data object is not necessarily implemented expressly as a tree structure but, rather, the tree structure merely provides a model of arbitrarily nested expression nodes that simplifies a discussion and understanding of the information within the dynamic data object that represents the expression.

FIG. 2D is a tree that has one simple compound expression node 242 that corresponds to the expression, or selection criteria, of the middle section 203 of FIG. 2A. The tree structure of FIG. 2E has three compound nodes 242, 246 and 248 and corresponds to the expression of the middle section 203 of FIG. 2B. Finally, the tree of FIG. 2F is back to a single expression node 248 once the AND expression node 246 has been deleted as also shown in the middle section 203 of FIG. 2C.

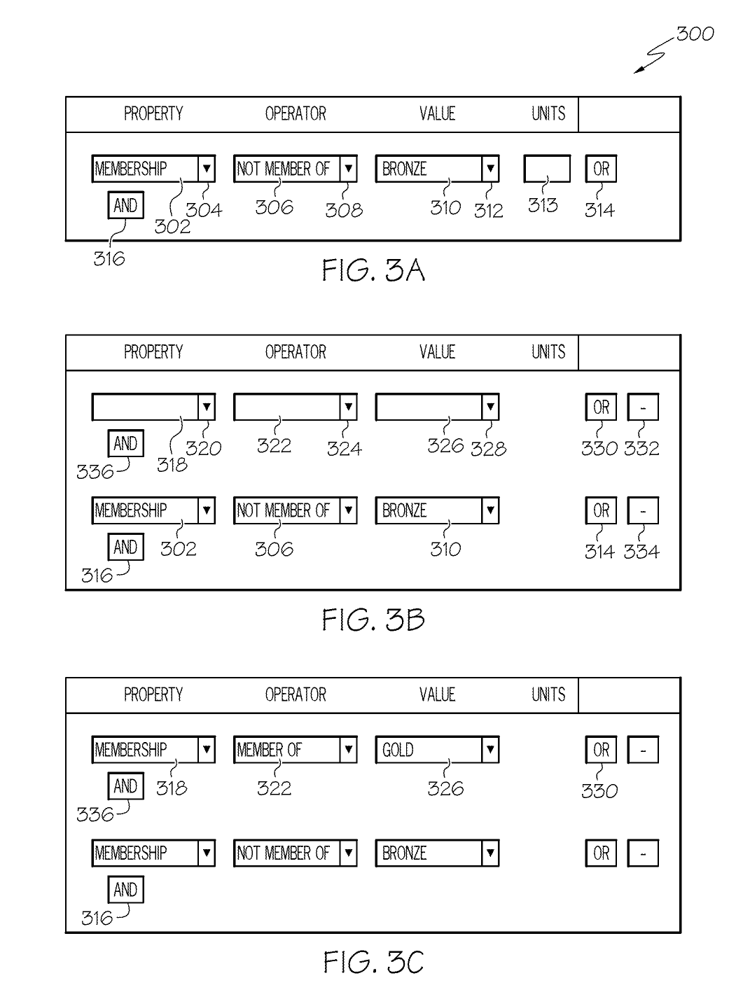

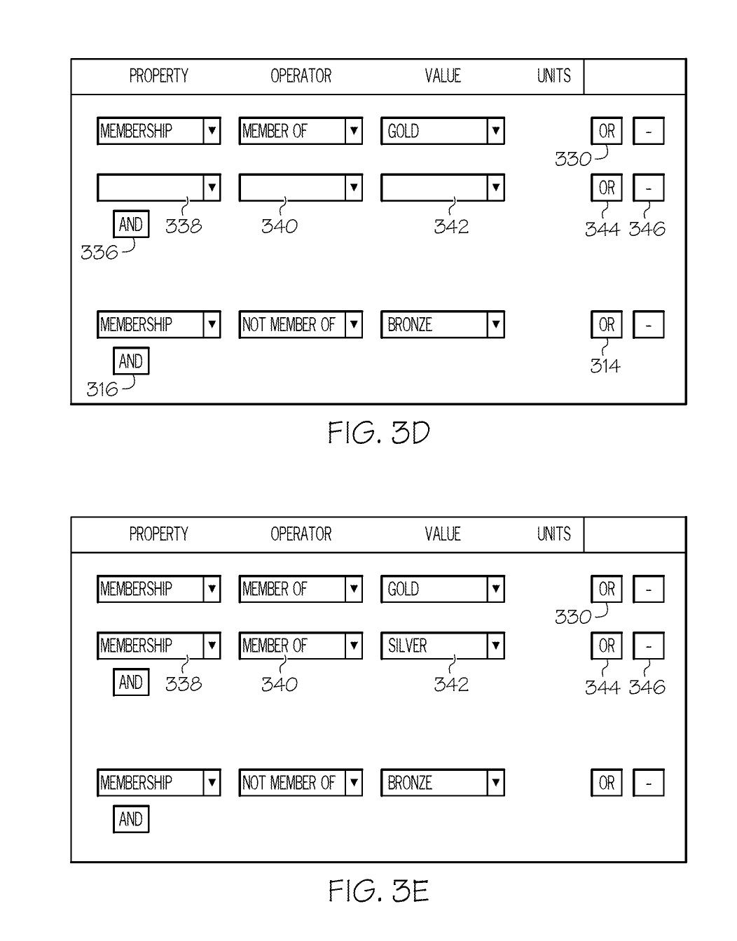

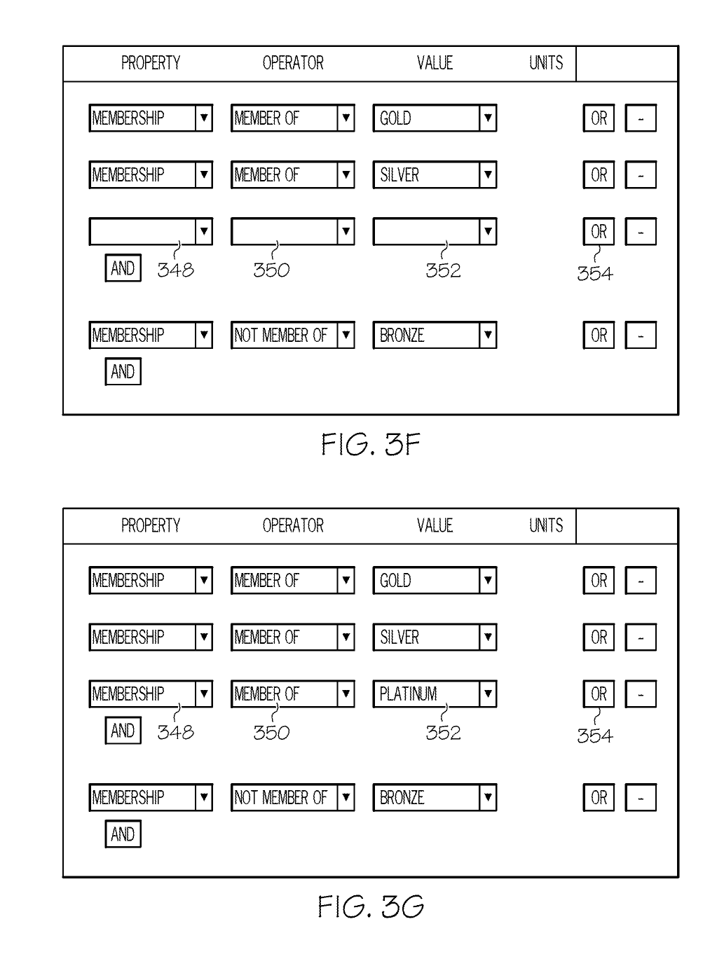

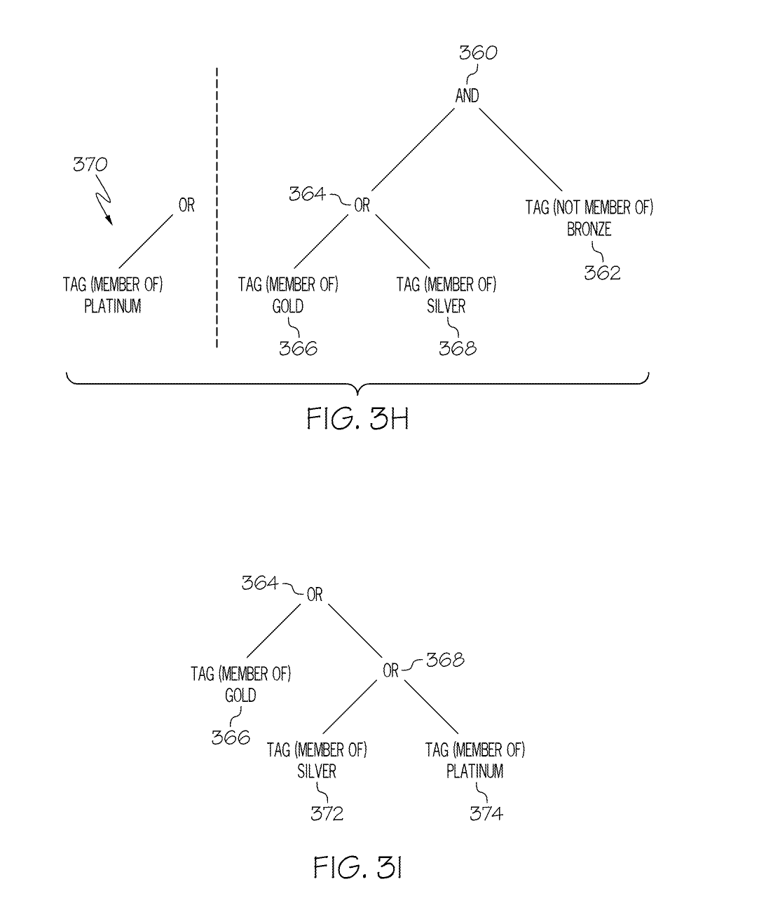

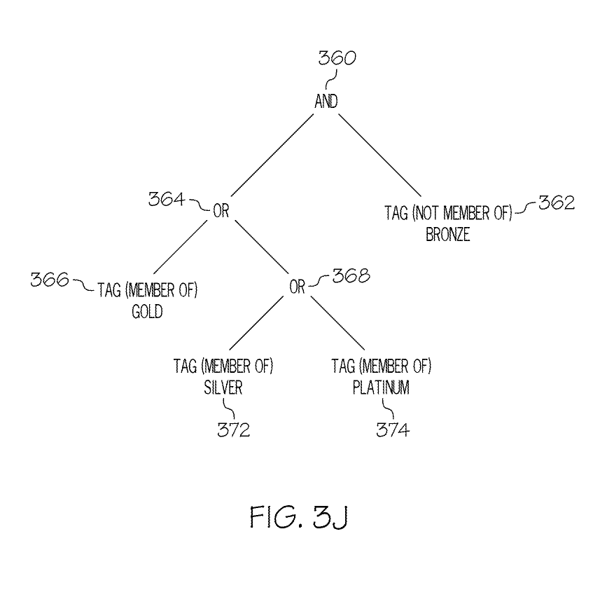

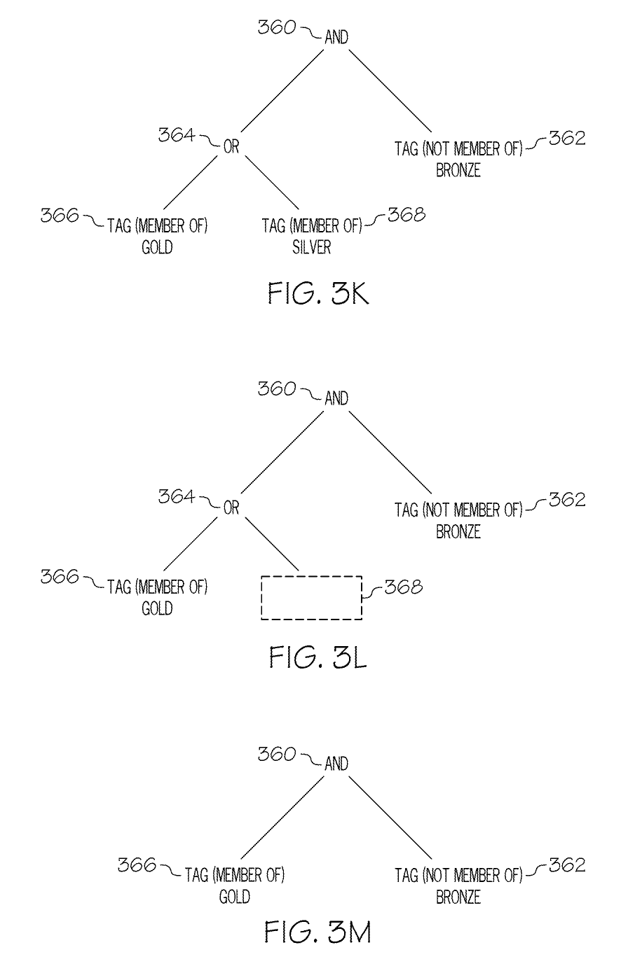

FIGS. 3A-3G provide another example of a user interface 300 that may be used to help a user build a query in a domain specific language. Many of the features of the user interface 200 of FIG. 2A and the user interface 300 of FIG. 3A are similar but that is not intended to convey that these similar elements are required in the user interface 300. For example, the single expression line of FIG. 3A has a PROPERTY of “MEMBERSHIP”, an OPERATOR of “NOT MEMBER OF” and a VALUE of “BRONZE”. One of ordinary skill will recognize that the same information can be conveyed by eliminating the PROPERTY of “MEMBERSHIP”. It could be considered that if the OPERATOR is either “MEMBER OF” or “NOT MEMBER OF”, then the expression line is inherently related to the groups or subsets to which a server belongs and the PROPERTY widget 302 is redundant and unnecessary. However, for purposes of consistency, the PROPERTY drop down widget 302 may be included, as shown in FIG. 3A.

The expression line of FIG. 3A includes a PROPERTY widget 302 and a control 304, an OPERATOR widget 306 and control 308, and a VALUE widget 310 and its control 312. Using these widgets and their respective controls, the user can be presented with a list of server PROPERTIES. These properties can relate to attributes or characteristics that can be used to distinguish one server from another. For example, as mentioned above, the use of “tags” or “smart tags” can be used to logically group servers. Thus, membership (or non-membership) in a group can be determined based on these “tags”. Additionally, the information related to “smart tags” allows further refinement such that selection criteria can include such things, for example, as the number of CPU cores, the CPU speed, the discovery date of a server, the amount of memory, the power type, and the total disk capacity.

The expression line (or widget) of FIG. 3A also includes an OPERATOR widget 306 that can represent a number of different comparison or mathematical operators. In operation, different types of operators are available for different types of properties. For example, for the property of “MEMBERSHIP”, the allowable operators are “MEMBER OF” or “NOT MEMBER OF”. The operators “<”, “>”, and “=” are not applicable to “MEMBERSHIP”. Conditional operators, for example, include {=, !=, >, >=, <, <=} for example. Arithmetic operators for example can include {+, −, *, /, %}. Boolean operators for example can include {AND, OR, XOR, NOR, NOT}. One of ordinary skill will recognize that there is no restrictions on the types of operators that can be supported.

There is also a VALUE widget 310 and accompanying control 312 that may, for example, display allowable values that the user can select from. The widgets 302, 306, 310 may all be different instances of a drop-down selection box widget or, alternatively, these widgets 302, 306, 310 could be different types of widgets as well (e.g., radio buttons, text box, etc.). An area 313 is present to display an associated sets of “units” that may be associated with the value of the VALUE widget 310.

There is also an OR button 314 and an AND button 316. IF the AND button 316 is selected, then an AND expression is inserted that displays appropriate content on the user interface 300. Similarly, if the OR button 314 is selected, then an OR expression is inserted that displays appropriate content on the user interface 300.

FIG. 3B illustrates an example user interface screen if the AND button 316 is selected. As more fully described below, the executable code of the client user interface listens to notifications of the insertion and creates an AND widget when it repaints the user interface screen that includes a second expression line, or widget, as shown in FIG. 3B.

Referring to FIG. 3B one expression widget can be comprised of individual widgets 302, 306, 310, 314, 334 and 316 and a second expression widget can be comprised of individual widgets 318, 320, 322, 324, 326, 328, 330, 332 and 336. The AND widget that was created by selecting the AND button 316 knows that an AND expression has two arguments and thus, the AND widget creates the second expression widget within the user interface screen. Each of the first and second expression widgets can now recognize that the expression node they represent is each part of a larger expression (an AND expression) and, thus, the delete buttons 332, 334 are now displayed to allow a user to remove either the first or second expression as desired.

The user interacts with the second expression widget to enter PROPERTY information, OPERATOR information, and VALUE information. The second expression widget is comprised of executable code that knows how to display selection information for the user and then update the display of the individual widgets 318, 322, 326 as the user interacts with these widgets to input selected information. The second expression widget also knows to display the OR button 330 to allow the insertion of an OR expression. The AND button 336 is displayed as a part of the parent AND widget. It is through these buttons 330, 316 that a user can build a complex, nested query as desired.

In FIG. 3C, the user can select the OR button 330 to insert an OR expression. The OR widget knows that an OR operator utilizes two arguments. One of the arguments for this OR operator will be the second expression (represented by the second expression node widget comprised of individual widgets 318, 322, and 326) and the OR widget will create a third expression node represented by the expression node widget (as shown in FIG. 3D) comprised of individual widgets 338, 340, and 342. The user can select values for the individual widgets as shown in FIG. 3E.

The values and arrangement of the three expression widgets as shown in FIG. 3E are depicted in a tree structure in the right-hand section of FIG. 3H. This tree structure has an AND node expression 360 that has two arguments: a compound expression node 364 and an expression node 362. The compound expression node 364 is an OR expression node that has two arguments: expression node 366 and expression node 368. The resulting selection criteria, or query, represented by that tree structure is to identify all servers having tags that indicate that the servers are members of either GOLD or SILVER and also are not members of BRONZE. As shown in the figures, the “MEMBER OF” and “NOT MEMBER OF” are operators (i.e., just like AND, OR, etc.) and have, in this example, one argument.

Referring to FIG. 3H, the user wants to modify the query to include servers that also may be members of PLATINUM and also not members of BRONZE. Such a refinement to the query is shown as a partial tree structure 370 in the left-hand portion of FIG. 3H. Inserting the partial tree portion of an expression node 370 at the expression node 368 will logically create the partial tree structure of FIG. 3I. An OR expression node is created that replaces the node 368 and has two arguments: a first expression node 372 that is the expression that was previously node 368 (e.g., MEMBER of SILVER) and a second expression node 374 that is the new selection criteria (e.g., MEMBER OF PLATINUM). The complete resulting tree structure is depicted in FIG. 3J. The AND expression node 360 continues to have two arguments but the structure of the child arguments of the OR expression node 364 has been changed.

In terms of the user interface, the tree structure of FIG. 3J can be obtained by selecting the OR button 344 of FIG. 3E. This will insert an OR expression node that has an empty operator compound expression as the first argument and a second argument is needed. The second argument will be obtained as a part of the insertion algorithm for the expression. The expression will then notify that an update has happened which will notify the AND widget that its arguments have changed and it needs to repaint. Thus, a fourth expression widget is created and displayed that is comprised of individual widgets 348, 350, 352, 354, as shown in FIG. 3F. The user can then fill in these widgets 350, 352, 354 with appropriate information as shown in FIG. 3G which will bring it into alignment with the tree structure in FIG. 3J. Selecting either OR button 330 or OR button 344 will not result in the same tree structure.

Referring back to FIG. 3E, a corresponding tree structure is shown in FIG. 3K. If the user selected the delete button 346, then (as shown in FIG. 3L) the expression node 368 requests and notifies to be deleted from the expression. The OR widget (corresponding to the OR expression node 364) and having the arguments represented by expression nodes 366 and 368 includes executable code that will recognize that with only one argument, it is no longer a valid OR expression. Thus, when the third expression widget comprised of individual widgets 338, 340, 342, 344 is deleted, the OR expression to which it belongs detects that deletion and also replaces itself with its remaining argument. This OR expression was one of the arguments of the AND expression represented by the AND expression node 360. Thus, the AND widget detects that one of its arguments has been changed and determines its remaining arguments based on the portions of the tree structure that remains. In particular, the second expression widget comprised of individual widgets 318, 322, 326, 330 becomes the second argument for the AND widget. The resulting user interface screen is shown in FIG. 3C and is represented by the tree structure depicted in FIG. 3M.

The example user interface described above utilizes a number of widgets in different configurations. Individual interface widgets can be commonly known user interface widgets such as menus, text boxes, selection lists, radio buttons, calendars, etc. These widgets are used to display information to the user in a particular format and can have additional functionality such as pop-up help bars or pop-up windows when a mouse-over or other event occurs.

Also discussed above are expression widgets, these widgets are constructed from individual widgets and their executable code is designed to display the appropriate individual widgets that make up a single expression node in an expression. An expression widget may represent a compound expression or a simple value expression. An expression node widget may include executable code that allows a user to select an operator (e.g., comparison operator, mathematical operator, membership operator, etc.) and one or more arguments that are appropriate for that operator. The expression widgets also have executable code that detects when the user interacts with individual widgets that comprise the expression widget. Thus, when the user selects a particular server PROPERTY as one of the expression arguments, the expression widget can update an individual OPERATOR widget to display only those operators that can be associated with the selected server PROPERTY. The VALUE widget can also have specific validation rules that are dependent upon the OPERATOR and PROPERTY that have been selected.

The user interface described above also includes compound expression widgets such as an AND widget and an OR widget. These compound widgets have a static operator, AND or OR, respectively. These compound widgets may include two argument widgets. The executable code that implements a compound widget is responsible for detecting when changes are made to either of its arguments and to edit itself accordingly, if appropriate.

While looking and acting differently, all of the various expression node widgets have effectively the same basic functionality. They represent an expression node (either a compound expression or simple value) with user interactive widgets and are listeners to the notifications (UPDATE and DELETE) for that expression node so that they can repaint and modify themselves accordingly. An expression node widget can also modify the expression node it is associated with which will in turn generate notifications that will cause it to modify or repaint itself. An expression widget may also pass through its expression (not only its argument) to other widgets, but provide the general structure of the user interface screen around other expression widgets. This “structure” widget may also be responsible for maintaining a dynamic data object that represents an expression representative of the different expression widgets and the way they are combined using the compound expression widgets. This dynamic data object can be communicated with external processes such as for example the BFC 112 described earlier. The “structure” widget may also be configured to receive information from external sources and display it within the user interface.

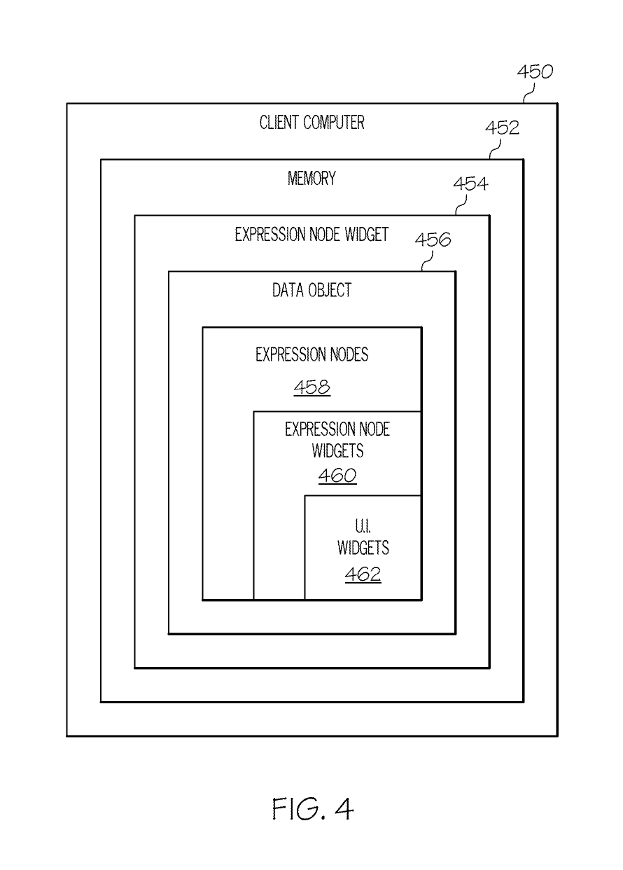

FIG. 4 illustrates a conceptual view of an expression node widget in accordance with the principles of the present disclosure. A user can use a client computer 450, and for example a web browser, to interact with a user interface described above. Within the client computer 450 there is computer memory 452 that stores an instance of the expression as described above. The expression node widgets register themselves as listeners to the expression nodes. As the user interacts with the user interface, the expression node widget 454 updates the expression node 458 to reflect the user's interaction and when it receives updates from the expression node, its appearance reflects the user's interactions or other updates as well. The expression node widget includes a data object 456 that represents an expression node such as, for example, server selection criteria or a query in a domain specific language in part or whole.

This expression represented by the data object 456 includes one or more expression nodes such as AND expressions and OR expressions described above. These compound expression nodes can be logically arranged in a hierarchical nature to form complex, nested selection criteria or queries. Each respective compound expression 458 may include at least one argument. Each of these arguments may be a nested expression that identifies properties, operators and values that allow a user to define individual portions of the selection criteria or queries. The nested expressions can be compound expression nodes or simple value expression nodes. Each expression node can have one or multiple associated expression node widgets to allow user interaction. To assist the user in this endeavor, each expression widget 460 can be comprised of a plurality of typical user interface widgets 462 that simplify data entry.

The different widgets described herein may exchange information and determine how to change based on events that are detected. In general, each widget can include executable code that invokes one or more event listeners. For example, a text box widget may implement an event listener that determines when the screen focus has shifted to it. As a result the text box widget will display a blinking cursor and any keystrokes entered by the user will be duplicated within the text box.

In addition to these types of event listeners that are typically included in the libraries or classes of modern programming languages, a widget can be designed to explicitly provide event notifications (e.g., fire an event). Thus, other widgets can be explicitly designed to include an event listener to detect the firing of a predetermined event. As described below, a widget may be described as notifying a listener of the occurrence of some event, the use of the term “notifying” is intended to encompass when a widget executes codes that explicitly creates a notification message for its listeners and also to encompass when interaction with a widget causes the occurrence of activity that can be automatically detected by a listener.

Using the model of a tree structure described above, there is inherently a hierarchy created such that a compound expression node can be referred to as a “parent node” and its two arguments can be referred to as respective “child nodes”. A parent node is considered as a higher-level node to its children nodes and the children nodes are considered to be lower-level nodes to its parent node. Within such a logical model structure, it becomes possible to describe expression nodes relative to one another (e.g., parent node, child node, root node, etc.) even if the data objects created and maintained in memory that represent the expression nodes are not actually arranged in a hierarchical manner. Also, an expression node in the tree can have different roles in that it can be a parent node to other nodes and at the same time be child node to a different parent node. Thus, sometimes it may be clearer to refer to a “higher-level” node and a “lower-level” node. Each of these expression nodes and compound expression nodes also correspond to a respective widget. Thus, herein when describing the interaction between nodes it is equivalent to describing the interaction between widgets and vice-versa. A parent node is always a listener to its children and will propagate UPDATE events as its own notifications while retaining the original source of the event. A parent node will never propagate a DELETE event, but will instead notify an UPDATE event of its own instead. In this way, all events in the tree propagate to the higher-level nodes all the way to the root.

As described below the various widgets are constructed so that changes can be easily detected and propagated throughout all the widgets without requiring parsing of an entire tree structure model or requiring each widget to have knowledge about the entire tree structure.

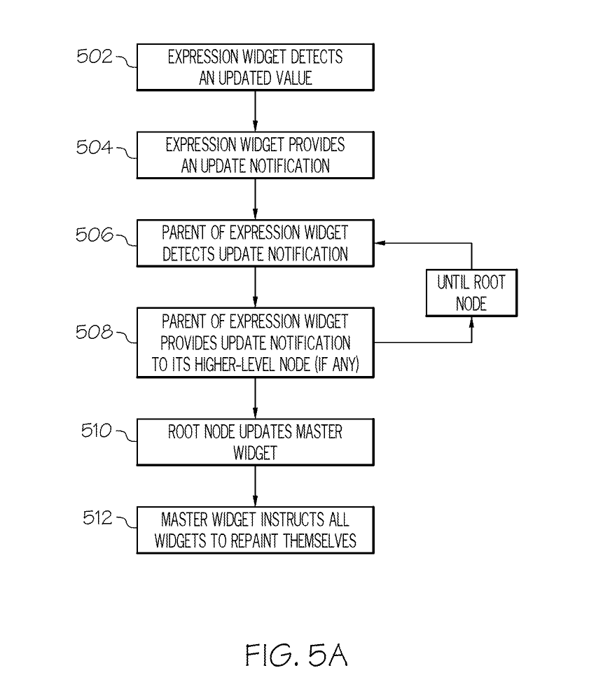

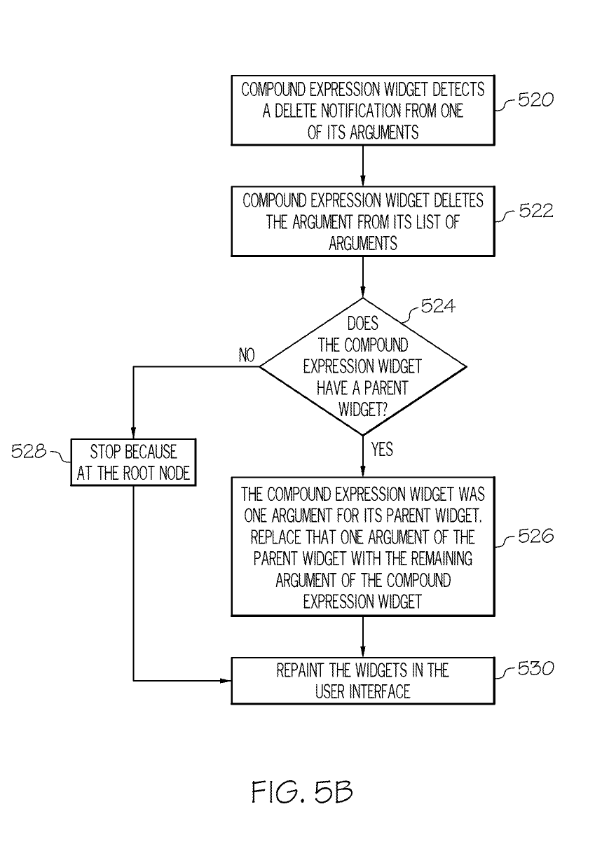

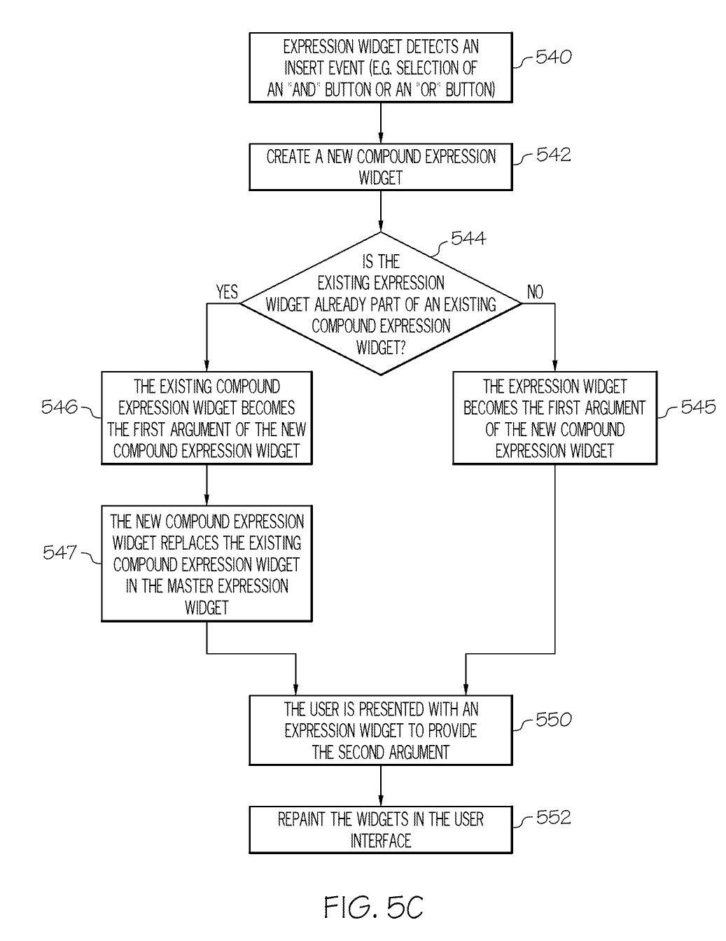

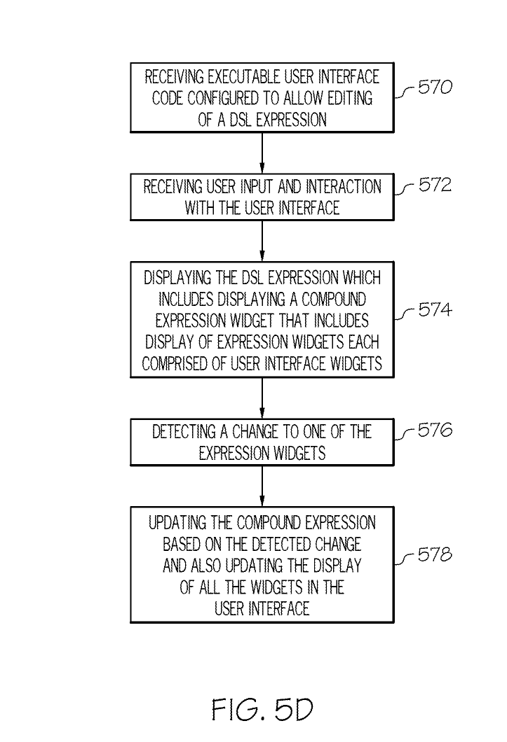

A compound expression node widget is comprised of executable code that displays the individual widgets that allow a user to specify an operator and arguments for that expression widget. Each compound expression node widget may also include executable code that listens for changes to any of the individual widgets that comprise the expression widget. FIG. 5A is a flowchart of an example process by which an expression widget can be updated in accordance with the principles of the present disclosure. Examples of expression widget updates are provided above and can include such activity as selecting a particular OPERATOR or PROPERTY and providing a certain VALUE.

An expression widget includes executable code that determines what individual widgets are to be displayed and how they are to be displayed. Once displayed, the expression widget is ready for interaction with a user. The expression widget, in step 502, can detect when one of its individual widgets is updated. When this occurs, the expression widget can, in step 504, provide an update notification. It may be unnecessary for the expression widget to know its location within the full expression tree or whether it is a part of a compound expression. The expression widget may merely use a predetermined function to produce a notification message.

The responsibility for listening for the update notification may rest with the parent widget associated with the expression widget. When a parent widget (e.g., a compound widget such as an OR widget) is created, part of that creation is to identify an identity of the arguments (e.g., children widgets) of the parent widget. Thus, the parent widget includes executable code that listens for and detects, in step 506, an update notification from one of its children widgets. In response, the parent widget can propagate, in step 508 the update notification message to its next-higher widget. Once the highest level widget receives the update notification message, the master widget can be notified and updated in step 510. For example, a change in a value in one of the expression widgets will change the expression tree that represents the selection criteria or query. The change to the root expression can be communicated with external processes to retrieve updated results based on the changed expression node.

The master widget may also instruct all the widgets, in step 512, to rebuild their respective widget makeup and repaint themselves within the user interface. For example, each expression widget and compound expression widget can include executable code to listen for such instructions from the master widget. One of ordinary skill will realize that optimizations for only repainting and rebuilding the portions of the widgets that changed could also be implemented.

According to the flowchart of FIG. 5A, an expression was dynamically updated while a user was interacting with the user interface and each widget relied on simply listening to its children widgets to ensure the necessary widgets were aware of the changes. This type of update mechanism can occur when any activity with the various widgets changes the master expression widget such as, for example, when an expression widget is deleted or a new compound expression is to be inserted. After either of these types of events, an expression widget or compound expression widget involved in the deletion or insertion will provide an update notification message. Other affected widgets will have code to listen for pertinent event notifications.

FIG. 5B illustrates a flowchart of an example process for deleting an expression widget in accordance with the present disclosure. The effects of the steps of FIG. 5B are illustrated in in FIGS. 3K-3M. An expression widget can detect that a delete event has occurred (e.g., the user has selected the delete button in the expression widget) and provide a delete notification message. In step 520 the compound expression widget (e.g., node 364 of FIG. 3K) detects the delete notification from one of its arguments (e.g., expression widget 368) and the compound expression widget deletes that expression widget from its list of arguments (in step 522). If the compound expression widget, in step 524, is determined not to have a parent widget, then the compound expression widget is the root node of the expression and further notifications and messages can stop, in step 528.

If, however, the compound expression widget does have a parent widget (e.g., AND widget 360), then additional steps are performed. In particular, the parent widget (e.g., AND widget 360) has two arguments, first argument (e.g., expression widget 362) and the compound expression widget (e.g., OR widget 364). Also, the compound expression widget now has only one argument (e.g., expression widget 366). In step 526, the compound expression widget deletes the one expression argument (e.g., expression widget 368) and replaces itself (e.g., OR widget 364) with its other expression argument. Its parent widget (e.g., AND widget 360) notices the change of its argument from the OR widget to the remaining argument and notifies its own parent of the update. These actions result in an update notification reaching the root expression widget which, in step 530, can cause all widgets to repaint themselves.

FIG. 5C illustrates a flowchart of an example process for inserting a new compound expression into an existing expression. The results of the steps of FIG. 5C are illustrated in FIGS. 2D-2F and FIGS. 3H-3J. In step 540, an expression widget (e.g., expression widget 366 of FIG. 3H) detects that either its AND button or OR button has been selected). As a result, a new compound expression is created in step 542. The next steps depend on whether the expression widget (e.g., expression widget 366) is part of an existing compound expression as determined in step 544.

If the expression (e.g., expression widget 242 of FIG. 2D) is not part of a compound expression, then the expression (e.g., expression widget 242) becomes one argument of the new compound expression (e.g., AND widget 246) in step 548.

If the expression (e.g., expression widget 368) is part of an existing compound expression (e.g., OR widget 364) then, in step 546, the existing compound expression (e.g., MEMBER OF Silver 372) becomes one argument of the new compound expression (e.g., OR widget 368). Also, in step 547, the new compound expression widget (e.g., OR widget 368) replaces the existing compound expression node (e.g., MEMBER OF Silver 372) in the existing expression. In FIGS. 3H and 3J it is depicted that the OR widget 368 has replaced the MEMBER OF Silver 372 as an argument for the OR widget 364.

In either instance, the insertion generates a notification so that the new compound expression widget presents the user with a new expression widget, in step 550, that allows the user to provide the second argument for the new expression widget. These actions result in an update notification reaching the root expression widget which, in step 552, causes all widgets to rebuild and repaint themselves.

FIG. 5D depicts a flowchart of an example process for providing a user interface in accordance with the principles of the present invention. As described above, a user interface is implemented using a plurality of different widgets. In particular, a top-level, or root, widget may be responsible for rendering a top-level appearance of the user interface. In the example above, the user interface was divided into three section and expression widgets were rendered in an example manner as well. One of ordinary skill will recognize that the layout of the user interface described above was provided by way of example and many variations can occur without departing from the scope of the present invention.

Within the expression node widget specialized widgets were used for specific purposes. For example, one specific expression widget described above includes a comparison widget that was comprised of two arguments and an operator. The comparison widget has a function of rendering a comparison expression (e.g., CPU cores>=4) within the user interface. In addition to comparison widgets, other expression widgets can include membership widget, mathematical widgets, and Boolean widgets. Some of these widgets may have more or less than two arguments.

In addition to expression widgets, compound expression widgets are described above which relate to various ways to combine a plurality of different arguments. The arguments for a compound expression widget can be a simple expression widget or another compound expression widget. Various combinations of the different arguments can include AND, OR, NOR, XOR, etc. Each compound expression widget may be responsible for rendering its arguments within the user interface and internally, the compound expression widget may be responsible for maintaining a list of its arguments (e.g., an expression widget) so that it can listen to whether any of these arguments fire an event notification.

In step 570, a computer, such as one executing a web browser, can receive user interface code that is executable in order to allow a user to edit a DSL expression. For example, the user interface code may be comprised of a JavaScript HTML page or a Java applet. Once the user interface is rendered for the user, then in step 572, the user interface can receive input and other actions based on the user's interaction with the user interface.

In step 574, the user interface is used to display the DSL expression as a plurality of related widgets. Each expression node widget is responsible for one small portion of the overall DSL expression. Thus, each widget can be simple in design, yet when combined, allow for rendering of complex, arbitrarily nested, DSL expression. The widgets that are displayed as part of displaying the DSL expression include expression widgets, as described above, and compound expression widgets, also as described above. The compound expression widgets can be combined, or arranged to build the DSL expression.

Changing one part of the DSL expression may be difficult to accomplish if the DSL expression is considered as a homogenous data object such that the relationship between all of the different widgets are somehow encoded within the structure of the different widgets. However, as explained above in the present disclosure, widgets are contemplated that have specific roles. Thus, there is one type of widget for rendering an AND expression and there is another type of widget for rendering a comparison (e.g. <=) expression. Furthermore, some widgets are considered to be a lower-level widgets when they are one of the arguments for a compound expression widget and some of the individual widgets that comprise an expression widget can be thought of as a lower-level widget relative to the expression widget.

Rather than designing widgets that relate to large portions of the expression, the different types of widget are designed to include information about their arguments. Thus, as depicted in step 576, a widget (e.g., an expression widget) may detect a change to one of its arguments. As described above, a change can include a deletion event, an insertion event, or a change of one of the values of the expression widget. Upon detecting such a change, the expression widget can generate an event notification that indicates a change has occurred and, possibly, what kind of change occurred.

The higher-level widget that has the changed expression widget as one of its arguments is designed to listen for these event notifications from their arguments. Based on the event notification, the higher-level widget can implement the change and may, if desired, send its own event notification to the widget that is one higher-level than it. In this way, event notifications can propagate up the expression tree without each widget knowing any more than what its arguments are. One of ordinary skill will recognize that event notifications could be designed to propagate down the tree structure as well.

Accordingly, in step 578, an expression data object can be updated when one of the expression widgets changes and every widget that comprises the DSL expression can be re-painted so that the user interface represents the updated expression data object.

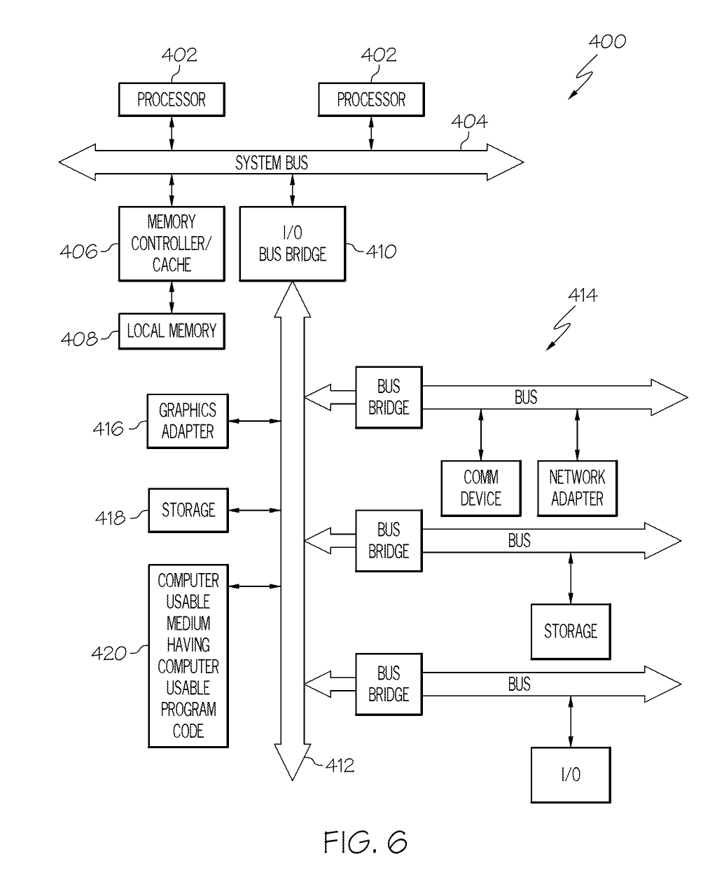

Referring to FIG. 6, a block diagram of a data processing system is depicted in accordance with the present disclosure. A data processing system 400, such as may be utilized to implement the hardware platform 108 or aspects thereof, e.g., as set out in greater detail in FIG. 1-FIG. 5D, may comprise a symmetric multiprocessor (SMP) system or other configuration including a plurality of processors 402 connected to system bus 404. Alternatively, a single processor 402 may be employed. Also connected to system bus 404 is memory controller/cache 406, which provides an interface to local memory 408. An I/O bridge 410 is connected to the system bus 404 and provides an interface to an I/O bus 412. The I/O bus may be utilized to support one or more busses and corresponding devices 414, such as bus bridges, input output devices (I/O devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 416, storage 418 and a computer usable storage medium 420 having computer usable program code embodied thereon. The computer usable program code may be executed to execute any aspect of the present disclosure, for example, to implement aspect of any of the methods, computer program products and/or system components illustrated in FIG. 1-FIG. 5D.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method of providing a user interface for editing a domain specific language expression, comprising:
displaying, by a master widget executing on a computer, the domain specific language expression within the user interface, wherein displaying the domain specific language expression comprises:
displaying, by a compound expression widget executing on a computer, a compound expression of the domain specific language expression, wherein displaying the compound expression comprises:
displaying, by a first expression widget executing on the computer, a first argument of the compound expression, and
displaying, by a second expression widget executing on the computer, a second argument of the compound expression;
detecting, by the compound expression widget, a change to either of the first expression widget and the second expression widget; and
in response to the change being detected, updating the compound expression based on the change.

2. The method of claim 1, wherein the first expression widget comprises an operator widget and a first argument widget.

3. The method of claim 2, wherein the first expression widget comprises a second argument widget.

4. The method of claim 1, wherein the operator widget is one of a comparison widget, a mathematical widget, a Boolean widget, and a membership widget.

5. The method of claim 1, wherein the compound expression widget is one of an AND widget and an OR widget.

6. The method of claim 1, wherein the first argument of the compound expression is a lower-level compound expression.

7. The method of claim 1 further comprising:
when the change relates to the first expression widget, generating, by the first expression widget, a first notification that the change occurred;
when the change relates to the second expression widget, generating, by the second expression widget, a second notification that the change occurred; and
listening, by the compound expression, for the first and second notification.

8. The method of claim 7, wherein the domain specific language expression includes a parent compound expression and the compound expression is one argument of the patent compound expression, the method comprising:
generating, by the compound expression, a third notification that the change occurred; and
listening, by the parent compound expression, for the third notification.

9. The method of claim 1, wherein the change is one of:
deleting either the first or second argument, and
inserting a second compound expression into the domain specific language expression.

10. The method of claim 1, comprising:
displaying, by the master widget, the updated domain specific language expression within the user interface.

11. A computer program product for providing a user interface for editing a domain specific language expression, comprising:
a computer readable storage medium having computer readable program code embodied therewith, the computer readable program code comprising:
computer readable program code configured to display, by a master widget, the domain specific language expression within the user interface,
computer readable program code configured to display, by a compound expression widget, a compound expression of the domain specific language expression;
computer readable program code configured to display, by a first expression widget, a first argument of the compound expression;
computer readable program code configured to display, by a second expression widget, a second argument of the compound expression;
computer readable program code configured to detect, by the compound expression widget, a change to either of the first expression widget and the second expression widget; and
computer readable program code configured, in response to the change being detected, to update the compound expression based on the change.

12. The computer program product of claim 11, wherein the first expression widget comprises an operator widget and a first argument widget.

13. The computer program product of claim 12, wherein the first expression widget comprises a second argument widget.

14. The computer program product of claim 11, wherein the operator widget is one of a comparison widget, a mathematical widget, a Boolean widget, and a membership widget.

15. The computer program product of claim 11, wherein the compound expression widget is one of an AND widget and an OR widget.

16. The computer program product of claim 11, wherein the first argument of the compound expression is a lower-level compound expression.

17. The computer program product of claim 11 further comprising:
computer readable program code configured, when the change relates to the first expression widget, to generate, by the first expression widget, a first notification that the change occurred;
computer readable program code configured, when the change relates to the second expression widget, to generate, by the second expression widget, a second notification that the change occurred; and
computer readable program code configured to listen, by the compound expression, for the first and second notification.

18. The computer program product of claim 17, wherein the domain specific language expression includes a parent compound expression and the compound expression is one argument of the patent compound expression, the computer program code comprises:
computer readable program code configured to generate, by the compound expression, a third notification that the change occurred; and
computer readable program code configured to listen, by the parent compound expression, for the third notification.

19. The computer program product of claim 11, wherein the change is one of:
deleting either the first or second argument, and
inserting a second compound expression into the domain specific language expression.

20. The computer program product of claim 11, comprising:
computer readable program code configured to display, by the master widget, the updated domain specific language expression within the user interface.

21. A system of providing a user interface for editing a domain specific language expression, comprising:
a processor coupled with a memory;
said memory storing code executable by the processor, said code configured, when executed, to implement a plurality of elements of the user interface;
a master widget configured to display the domain specific language expression within the user interface;
a compound expression widget configured to display a compound expression of the domain specific language expression;
a first expression widget configured to display a first argument of the compound expression, and
a second expression widget configured to display a second argument of the compound expression;
the compound expression widget further configured to detect a change to either of the first expression widget and the second expression widget; and
the master widget configured to, in response to the change being detected, update the compound expression based on the change.

22. The system of claim 21, wherein the first expression widget comprises an operator widget and a first argument widget.

23. The system of claim 22, wherein the first expression widget comprises a second argument widget.

24. The system of claim 21, wherein the operator widget is one of a comparison widget, a mathematical widget, a Boolean widget, and a membership widget.

25. The system of claim 21, wherein the compound expression widget is one of an AND widget and an OR widget.

26. The system of claim 21, wherein the first argument of the compound expression is a lower-level compound expression.

27. The system of claim 21 further comprising:
when the change relates to the first expression widget, the first expression widget is configured to generate a first notification that the change occurred;
when the change relates to the second expression widget, the second expression widget is further configured to generate a second notification that the change occurred; and
the compound expression is configured to listen for the first and second notification.

28. The system of claim 27, wherein the domain specific language expression includes a parent compound expression and the compound expression is one argument of the patent compound expression, and:
the compound expression is configured to generate a third notification that the change occurred; and
the parent compound expression is configured to listen for the third notification.

29. The system of claim 21, wherein the change is one of:
deleting either the first or second argument, and
inserting a second compound expression into the domain specific language expression.

30. The system of claim 21, wherein the master widget is configured to display the updated domain specific language expression within the user interface.
